(19) United States
(12) Patent Application Publication
(10) Pub. No.: US 2010/0262466 A1
(43) Pub. Date: Oct. 14, 2010

(54) APPARATUS, SYSTEM, AND METHOD FOR ORGANIZATIONAL MERGER AND ACQUISITION ANALYSIS

(76) Inventors: Nicholas Smith, Santa Fe, NM (US); Rebecca Carrier, Santa Fe, NM (US)

Correspondence Address: Kunzler Needham Massey & Thorpe, 8 EAST BROADWAY, SUITE 600, SALT LAKE CITY, UT, 84111, US

(21) Appl. No.: 12/758,682

(22) Filed: Apr. 12, 2010

Related U.S. Application Data
(60) Provisional application No. 61/168,590, filed on Apr. 11, 2009.
(60) Provisional application No. 61/242,015, filed on Sep. 14, 2009.

(51) Int. Cl. G06Q 10/00; G06F 17/30

(52) U.S. Cl. 705/10; 707/802; 707/E17.044

(57) ABSTRACT

An apparatus, system, and method are disclosed for merger and acquisition analysis. A survey module may provide a survey regarding organizational aspects, including both subjective aspects and objective aspects. A database module may gather responses to the survey regarding a first company and a second company that are merger candidates into a database of survey data. A reporting module may display a graphic that presents a visual summary of the survey data for each organizational aspect. A recommendation module may generate action recommendations to address root causes of impacts regarding the merger based upon the survey data in the database. The visual summaries may be arranged in a pictorial representation of an interrelationship between the organizational aspects that may be interactively selectable by a user.

### CROSS-REFERENCES TO RELATED APPLICATIONS

This application claims the benefit of U.S. Provisional Patent Application No. 61/168,590 entitled “Apparatus, System, and Method for Organizational Merger and Acquisition Analysis” and filed on Apr. 11, 2009 for Nicholas Smith et al. and U.S. Provisional Patent Application No. 61/242,015 entitled “Apparatus, System, and Method for Organizational Merger and Acquisition Analysis” and filed on Sep. 14, 2009 for Nicholas Smith et al., which is incorporated herein by reference.

### BACKGROUND

1. Field of the Invention

This invention relates to business process management and more particularly relates to merger and acquisition management.

2. Description of the Related Art

The increase in merger and acquisition activity in recent years has highlighted the long recognized but unfulfilled need for a better way to analyze the “best fit” for organizations, and to avoid issues with the integration process. Numerous documented case studies report that most corporate combinations fail to attain the projected business results.

In an attempt to improve the effectiveness of mergers and acquisitions, organizations have resorted to much greater analysis of the “hard” or objectively quantifiable aspects of this process. They further segment target businesses and collect copious amounts of data. The effect has been to increase the time taken to make a decision about a merger or acquisition, with little if any improvement in the outcome. Existing approaches are ineffective in addressing the “soft” or more subjective aspects of culture, people, communication and working practices, or in considering the unintended consequences and non-obvious impact of any integration activity on the host organization. It often causes so much disruption to the host company that it actually creates a disadvantage in their field of operation because it gives their competitors an opportunity to capitalize on the dysfunctionality and chaos that is caused around the merger or acquisition.

### SUMMARY

From the foregoing discussion, it should be apparent that a long-felt unmet need exists for an apparatus, system, and method that yield consistently more successful outcomes in mergers and acquisitions. Beneficially, such an apparatus, system, and method would provide a holistic, macro view of both the target and the host organization.

The present invention has been developed in response to the present state of the art, and in particular, in response to the problems and needs in the art that have hitherto proven intractable under currently available merger and acquisition management tools. Accordingly, the present invention has been developed to provide an apparatus, system, and method for merger and acquisition analysis that overcome many or all of the above-discussed shortcomings in the art.

An object of the present invention is to employ complex systems thinking methodology to allow the host organization to compare both the “hard” or objective elements of the merger and the “soft” or subjective elements. This enables a more accurate basis for assessing a “go” or “no go” decision on a merger or acquisition.

A further object of the invention is to provide a methodology for clearly communicating the areas of synergy, barriers and impacts in a simple, yet elegant framework based upon extensively researched elements in an organization. These predetermined elements facilitate the comparison of information between the target and the host.

Another object of the invention is to reduce the time taken to collect and organize the information by removing the need for a large team of external resources to collect data, and allows internal resources to rapidly collect, manipulate and interpret the information. A data-processing engine organizes and displays the qualitative and quantitative data to make obvious the synergies and the barriers.

The present invention manages the entire process from a novel perspective, from target selection, to best fit, to go/no go, to targeting problem areas, to creating a complete action or 90-day plan, through integration of the entities and measuring the success of the integration process. All of this is accomplished from a macro, systems thinking perspective that combines objective and subjective data, instead of a cause and effect, linear and purely quantifiable perspective.

An elegant display enhances communication, interpretation and understanding. One can actually see the gaps in the data where further analysis is needed, impacts of mismatches/barriers as well as synergies, interconnections between elements within both the host and target, and between host and target, root cause of issues, macro strategic issues versus the purely tactical or operational issues, and measurable changes during the implementation stage. The host company can also test plan actions to correct issues with the use of the invention prior to implementing the actions, saving time and resources. All this is achieved more rapidly with an on-line web-based collection process, more effectively because it broadens the involvement by engaging subject matter experts (SMEs) from both organizations who are best positioned to predict the issues and find solutions, more sustainable because it focuses upon the real barriers to mergers and acquisitions—the soft and cultural issues, and more inexpensively because it does not require large teams of expensive consultants to collect, analyze, interpret and write reports.

The apparatus for merger and acquisition analysis is provided with a plurality of modules configured to functionally execute the necessary steps of providing a survey regarding organizational aspects, including both subjective aspects and objective aspects, gathering responses to the survey regarding a first company and a second company into a database of survey data, wherein the first company and the second company are candidates for a merger, and displaying a graphic that presents a visual summary of the survey data for each organizational aspect, the visual summaries arranged in a pictorial representation of an interrelationship between the organizational aspects. These modules in the described embodiments include a survey module that provides the survey, a database module that gathers the responses, and a reporting module that displays the graphic.

In one embodiment of the apparatus, the survey may solicit a perceptional characterization of the organizational aspect among a set of predetermined responses. In a further embodiment, the predetermined responses may comprise one or more of strong, neutral, weak, and unknown, and the visual summary may juxtapose a summary of the survey data for the first company with that of the second company. Alternatively, the predetermined responses may comprise one or more of synergy, potential barrier, and barrier, as regards the integration of the first company with the second company, and the visual summary may juxtapose summaries of the survey data for one or more demographic groups.

The apparatus is further configured, in one embodiment, to color-code the visual summary by predetermined response. The perceptional characterization may be supplemented by one or more follow-up questions, comprising at least a request for an example to support the predetermined response.

In an embodiment, the pictorial representation may comprise concentric circles, having one or more core aspects centrally disposed, one or more strategic aspects disposed around an inner circle, one or more operational aspects disposed around a middle circle, and one or more external aspects disposed around an outer circle. The subjective aspects may comprise one or more of culture, leadership, innovation, people, internal communications, external communications, new business, and stakeholders. The objective aspects may comprise one or more of direction, planning, operations, structures, and measurement.

A system also presented for merger and acquisition analysis. The system may be embodied by the apparatus operationally coupled to a computing environment. In particular, the computing environment, in one embodiment, may be internet-based. The visual summary may be selected by a user to reveal more detailed survey data with respect to the corresponding organizational aspect.

The system may further include a recommendation module that generates action recommendations to address root causes of impacts regarding the merger based upon the survey data in the database, wherein the visual summary may be selected by a user to reveal the impacts, root causes, and action recommendations with respect to the corresponding organizational aspect.

A method is also presented for merger and acquisition analysis. The method in the disclosed embodiments substantially includes the steps necessary to carry out the functions presented above with respect to the operation of the described apparatus and system. In one embodiment, the method includes providing a survey regarding organizational aspects, including both subjective aspects and objective aspects, gathering responses to the survey regarding a first company and a second company into a database of survey data, wherein the first company and the second company are candidates for a merger, and displaying a graphic that presents a visual summary of the survey data for each organizational aspect, the visual summaries arranged in a pictorial representation of an interrelationship between the organizational aspects.

In one embodiment of the method, the visual summary may juxtapose a summary of the survey data for the first company with that of the second company, to facilitate making a decision whether or not to proceed with the merger. In another embodiment, the visual summary may juxtapose summaries of the survey data for one or more demographic groups, to facilitate integration of the first company with the second company, and in a further embodiment may comprise a step of repeating the steps of gathering and displaying, to facilitate ongoing measurement and tracking of the integration.

The method also may include a step of generating action recommendations to address root causes of impacts regarding the merger based upon the survey data in the database. In a further embodiment, the step of generating action recommendations may further comprise causal loop analysis to determine whether the action recommendations are sustainable and convergent toward success of the merger.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a system of the present invention;

FIG. 2 is a schematic block diagram illustrating a merger and acquisition analysis apparatus according to the present invention;

FIG. 3 is a welcome screen of a baseline survey regarding a first company or a second company;

FIG. 4 is an input screen of the survey that solicits a perceptional characterization of organizational aspects of the company in question;

FIG. 5 is a dialog box specifying the output of a reporting module as a baseline of the companies in question;

FIG. 6 is a visual summary of the survey data for an organizational aspect that juxtaposes a summary of the survey data for the first company with that of the second company;

FIG. 7 is an arrangement of the visual summaries in a pictorial representation of an interrelationship between the organization aspects;

FIG. 8 is a welcome screen of an integrative survey regarding alignment of a first company with a second company;

FIG. 9 is an input screen of the survey that solicits a perceptional characterization of organizational aspects of the alignment between the companies;

FIG. 10 is the dialog box specifying the output of the reporting module as to the alignment between the companies;

FIG. 11A is a visual summary of the survey data for an organizational aspect that juxtaposes a summary of the survey data for the first company with that of the second company across demographic groups;

FIG. 11B is an arrangement of the visual summaries in the pictorial representation of an interrelationship between the organization aspects of the alignment between the companies;

FIG. 12A is a visual summary of the survey data for an organizational aspect that combines the survey data for the first company with that of the second company into a single representation for the post-merger company;

FIG. 12B is an arrangement of the visual summaries in the pictorial representation of an interrelationship between the organization aspects of the post-merger company;

FIG. 13 is an output screen showing more detailed survey data received in response to a follow-up question regarding the perceptional characterization;

FIG. 14 is a schematic flow chart diagram illustrating one embodiment of a method for merger and acquisition baseline analysis in accordance with the present invention;

FIG. 15 is a schematic flow chart diagram illustrating one embodiment of a method for merger and acquisition integrative analysis in accordance with the present invention; and

FIG. 16 is a more detailed schematic flow chart diagram illustrating one embodiment of a method for merger and acquisition integrative analysis as performed by the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Aspects of the present invention are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

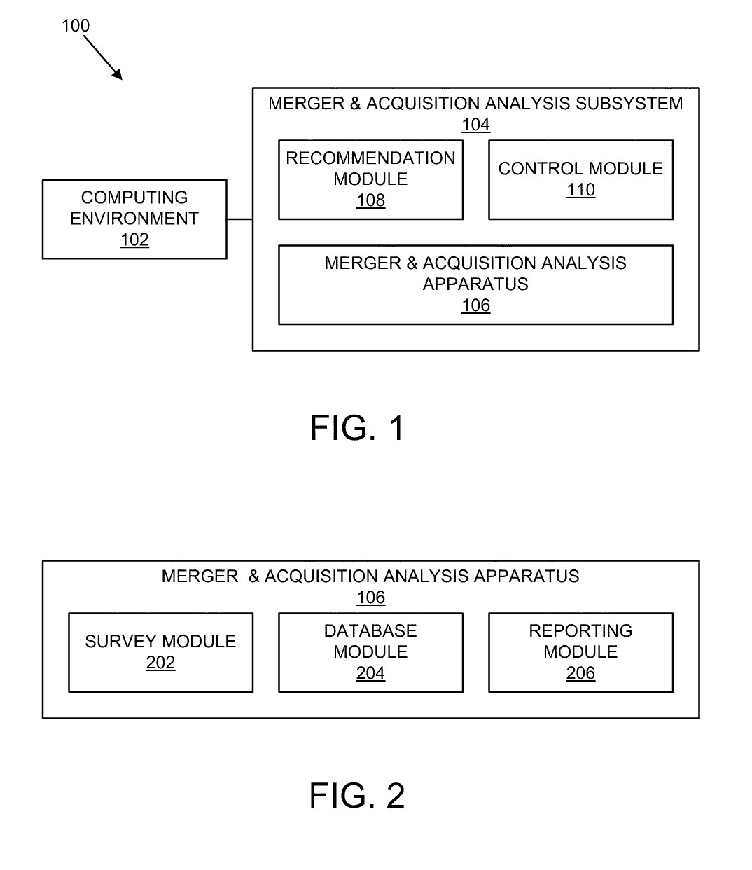

FIG. 1 is a schematic block diagram illustrating a system 100 of the present invention, comprising a computing environment 102 and a merger and acquisition analysis subsystem 104. The subsystem 104 further comprises a merger and acquisition analysis apparatus 106, a recommendation module 108, and a control module 110. In an embodiment, the foregoing components of the subsystem 104 may be fully or partially implemented within hardware or software of the computing environment 102. The apparatus 106 may be activated one or more times by the control module 110. Successive results of the merger and acquisition analysis from the apparatus 106 regarding companies that are candidates for the merger or acquisition may then be used in conjunction with the recommendation module 108 to reach a decision whether or not to proceed, and if so to facilitate the ongoing integration of the companies.

FIG. 2 is a schematic block diagram illustrating the merger and acquisition analysis apparatus 106 according to the present invention, comprising a survey module 202, a database module 204, and a reporting module 206. The survey module 202 provides a survey regarding organizational aspects of the companies, including both subjective aspects and objective aspects. In one embodiment, the survey may be interactive. In another embodiment, the survey may be paper-based, to be scanned or otherwise entered via the survey module 202 at a later time. The survey may be administered to personnel of one or more of the companies or organizations within the companies. In a further embodiment, the survey may include follow-up questions.

The database module 204 gathers responses to the survey regarding the companies into a database of survey data. The database may be relational, hierarchical, flat, and so forth. The process of gathering into the database may include statistical analysis, data mining, heuristic analysis, and the like. In one embodiment, the database may incorporate other information regarding the companies beyond that obtained via the survey. In a further embodiment, the database may incorporate historical data regarding other mergers and acquisitions.

The reporting module 206 displays a graphic that presents a visual summary of the survey data for each organizational aspect, the visual summaries arranged in a pictorial representation of an interrelationship between the organizational aspects. In one embodiment the visual summary may comprise a bar chart, a pie chart, or the like. The pictorial representation may be one-dimensional, such as a spectrum, two-dimensional, such as a quadrant chart, or three-dimensional, such as a cluster diagram, cloud diagram, mind map, and so forth. In a further embodiment, the pictorial representation may be simplified so that only vital information remains and unnecessary detail has been removed, as in systems thinking based system mapping. These maps lack scale, and distance and direction are subject to change and variation, but the relationship between points is maintained, the points comprising the visual summaries.

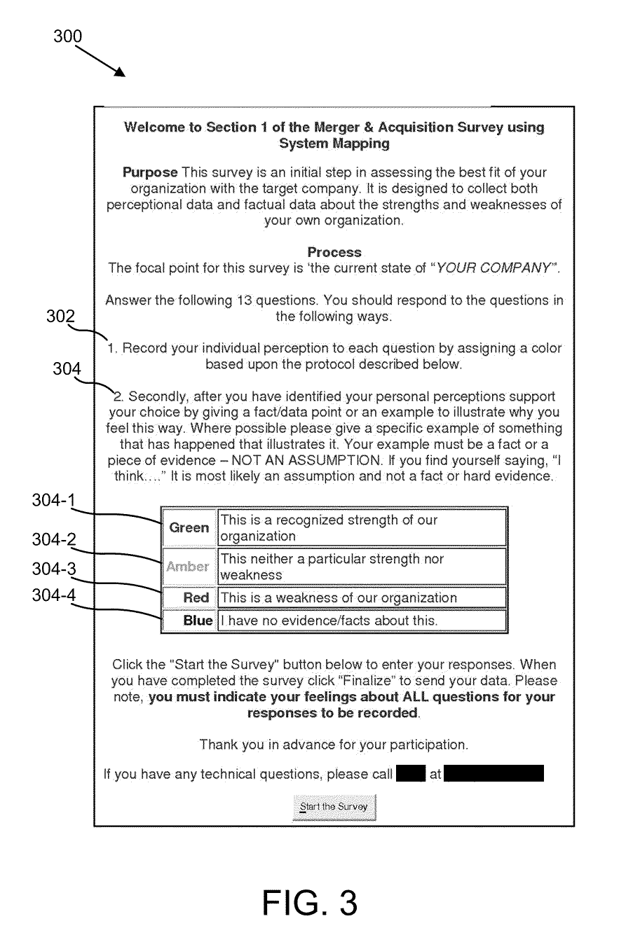

FIG. 3 is a welcome screen 300 of a baseline survey regarding a first company or a second company. In one embodiment, the first company may be a host, and the second company may be an acquisition target of the host. The survey solicits a baseline perceptional characterization 302 of each organizational aspect of the company. In the illustrated embodiment, there are four predetermined responses 304 which are color-coded. A green response 304-1 indicates that the organizational aspect is perceived as a strength of the company. A yellow response 304-2 indicates that the organizational aspect is perceived as neutral for the company, being neither a strength nor a weakness. A red response 304-3 indicates a perceived weakness with respect to the organizational aspect in question. If the survey respondent does not have any information as a basis for a perceptional characterization 302, then a grey response 304-4 is appropriate, indicating that the information is unknown.

For all but the grey response 304-4, a follow-up question 306 may be posed, seeking a specific example to support the perceptional characterization 302. In a further embodiment, additional follow-up questions 306 may be posed to explore the response 304 in greater detail.

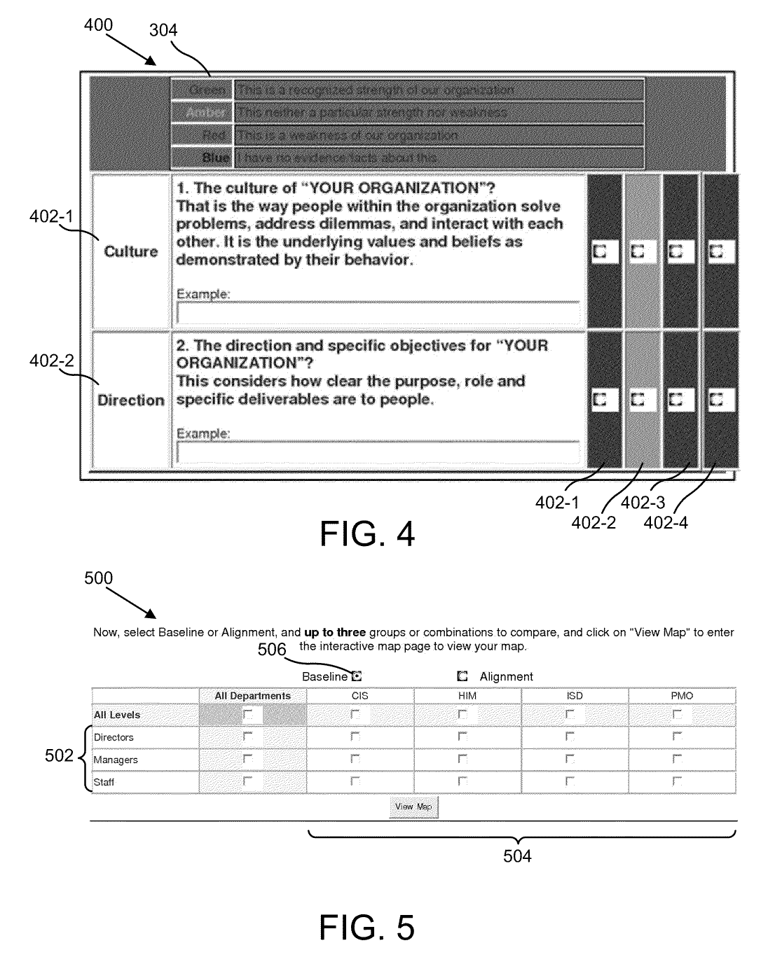

FIG. 4 is a baseline input screen 400 of the survey that solicits a perceptional characterization 302 of organizational aspects 402 of the company in question. The baseline predetermined responses 304 are repeated at the top of the input screen 400 for the convenience of the respondent. Corresponding color-coded checkboxes 404-1 to 404-4 are provided for the selection of the response in regards to each organizational aspect 402.

The organizational aspects 402 may comprise a subjective aspect 402-1 such as culture. Culture refers to the way people within the system solve problems, address dilemmas, and interact with each other. It comprises the underlying values and beliefs of people as demonstrated by their behavior. It's “how we do things around here” in a particular company. Other subjective aspects 402-1 may include leadership, innovation, people, internal communications, external communications, new business, stakeholders and so forth.

Leadership comprises the decision-making process of the leaders (both formal and informal) within the company. It focuses on the quality of their decisions and the actions they take to support these decisions. This is not just the leadership team, but people in the company that take responsibility and act as leaders. Innovation comprises new ideas and developments that seek to improve, or make changes to, the way the company works. It focuses upon what is being done today to enable tomorrow. This includes people development, process development, working methods or other activities that are designed to make things better in the future.

People are the personnel in terms of headcount, along with their capabilities, motivation, workloads, knowledge, skills and experience. Internal communication includes the methods, style, content, frequency and appropriateness of communication between people.

External communications includes the methods, style, content, frequency and appropriateness of communication to external groups or individuals. New business refers to how the company obtains new business, sells its products, and gains support. This focuses on the sales process, but also includes gaining buy-in or support for ideas, both internally and externally. Stakeholders are viewed in terms of how their needs are understood and met by the company. This includes the needs of customers, distributors, shareholders or other external parties.

The organizational aspects 402 may also comprise an objective aspect 402-2 such as direction. Direction includes the organization's purpose, mission, vision and the like. It focuses on whether these things are clear, suitable, viable, and so forth. Other objective aspects 402-2 may include operations, planning, structures, measurement, and the like.

Operations comprise the activities that drive the day-to-day functioning of the company. This is not the operations department per se, but how things get done on a day-to-day basis. This focuses on the implementation of the plans and strategies. Planning covers the strategies and plans that exist to deliver on the direction and decisions. This includes the planning process as well as the plans themselves. Structures are the frameworks or other structures that exist to support the way the company operates. This includes the organizational structures, IT systems, personnel systems, contracts or any other processes, systems, or frameworks. Measurement comprises the measures in place to gauge the success of the company. This is not the finance department per se, but includes such things as finance, quality, customer satisfaction, operational metrics, people performance metrics, and so forth.

FIG. 5 is a dialog box 500 specifying the output of a reporting module 206 as a baseline of the companies in question. The output may be selected according to demographic groups 502 and organizations 504 within the company. In the illustrated embodiment, the demographic groups 502 comprise management levels, and the organizations 504 comprise departments. In the example shown, the baseline check box 506 has been selected, which has the implicit effect that all levels and all departments will be rolled together into a single company-wide summary, without having to explicitly so specify.

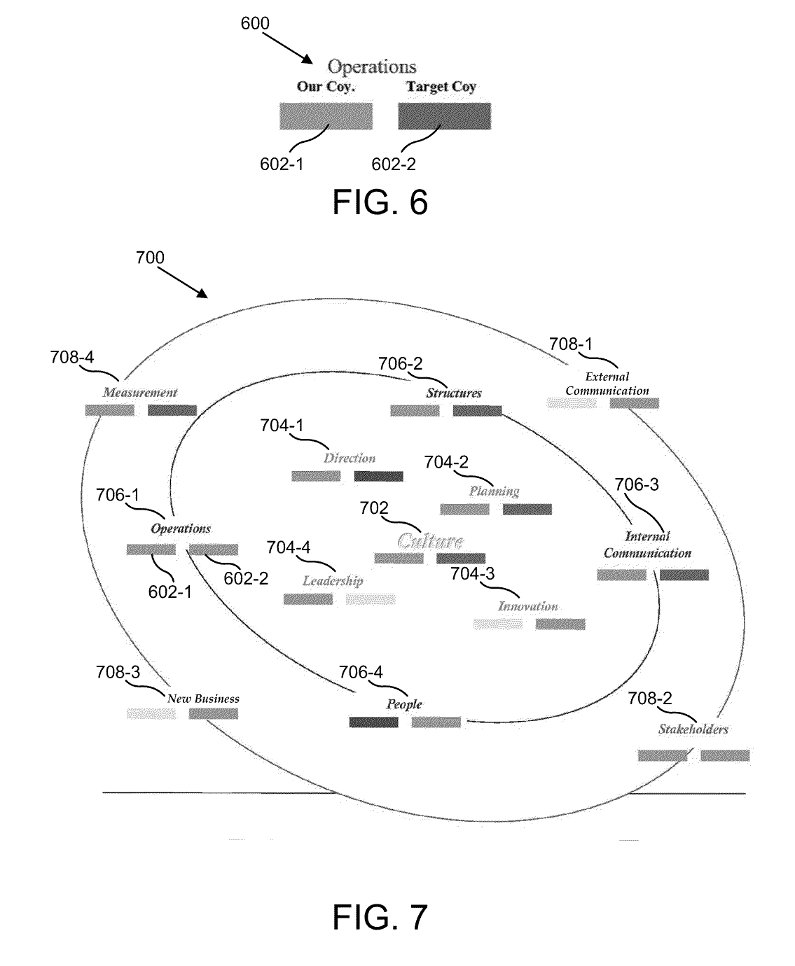

FIG. 6 is a visual summary 600 of the survey data for an organizational aspect 402 that juxtaposes a summary of the survey data for the first company, comprising a first colored bar 602-1, with that of the second company, comprising a second colored bar 602-2. In the example shown, the first colored bar 602-1 is yellow, implying that the organizational characteristic 402 of operations is perceived as neutral for the first company. The second colored bar 602-2 is grey, implying that the same organizational characteristic 402 is unknown with regards to the second company, which might well be the case if the survey were administered only to personnel of the first company as a host company considering the second company as an acquisition target.

FIG. 7 is an arrangement of the visual summaries 600 in a pictorial representation 700 of an interrelationship between the organization aspects 402, comprising the output of the reporting module 206. The pictorial representation 700 is in baseline mode, as specified earlier via the dialog box 500, and as such may also be referred to as a merger map.

As shown, the pictorial representation 700 comprises a set of concentric circles. Centrally disposed in the pictorial representation 700 is a core aspect 702 of culture. In a further embodiment, more than one core aspect 702 may be present. Disposed about an inner circle are strategic aspects 704, including that of direction 704-1, planning 704-2, innovation 704-3, leadership 704-4, and so forth. Disposed about a middle circle are operational aspects 706, including that of operations 706-1, structures 706-2, internal communication 706-3, people 706-4, and so forth. Disposed about an outer circle are external aspects 708, including that of external communications 708-1, stakeholders 708-2, new business 708-3, measurement 708-4, and so forth.

The pictorial representation 700 may suggest an interrelationship analogous to that of a planetary solar system. The organizational aspects 402 exhibit mutual interdependence analogous to gravity, anchored and illuminated by a core organizational aspect 702 analogous to a sun, and aggregated into groups of an increasingly peripheral character analogous to orbits. Another embodiment of an analogous circular pictorial representation 700 might be a clock face, and the like. The colors of the visual summaries 600 together with the geometry of the pictorial representation 700 are able to convey key insights and the interdependence of different parts of the organization in a very intuitive way. The layout is designed to provide the big picture in one page, so that it can be easily grasped by users in all demographic groups 502, regardless of education or any particular expertise. The user can very quickly focus in on where the issues are and drill down to more detailed survey data, analysis, action recommendations, and the like, without having to pore over a voluminous report.

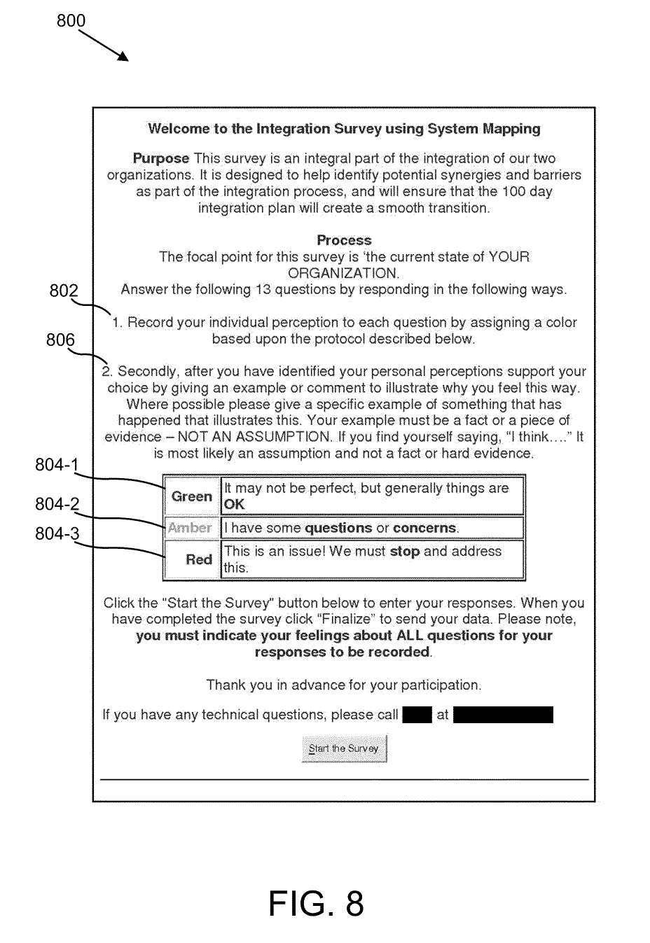

FIG. 8 is a welcome screen 800 of an integrative survey regarding alignment of a first company with a second company. In one embodiment, the first company may be a host, and the second company may be an acquisition target of the host. The survey solicits an integrative perceptional characterization 802 of each organizational aspect 402 of the companies. In the illustrated embodiment, there are three predetermined responses 804 which are color-coded. A green response 804-1 indicates that the organizational aspect 402 is perceived as an area of synergy and strong alignment between the companies. A yellow response 804-2 indicates that the organizational aspect 402 is perceived as a potential barrier to integration due to questionable alignment between the companies. A red response 804-3 indicates a perceived barrier due to poor alignment of the companies with respect to the organization aspect 402 in question. The foregoing color coding may be suggestive of a traffic signal, respectively implying go, proceed with caution, and stop. As noted above, the use of color in this fashion helps to capture and convey key insights in a very intuitive way.

For all of the predetermined responses 804, a follow-up question 806 may be posed, seeking a specific example, as well as factual details, to support the perceptional characterization 802. In a further embodiment, additional follow-up questions 806 may be posed to explore the response 804 in greater detail.

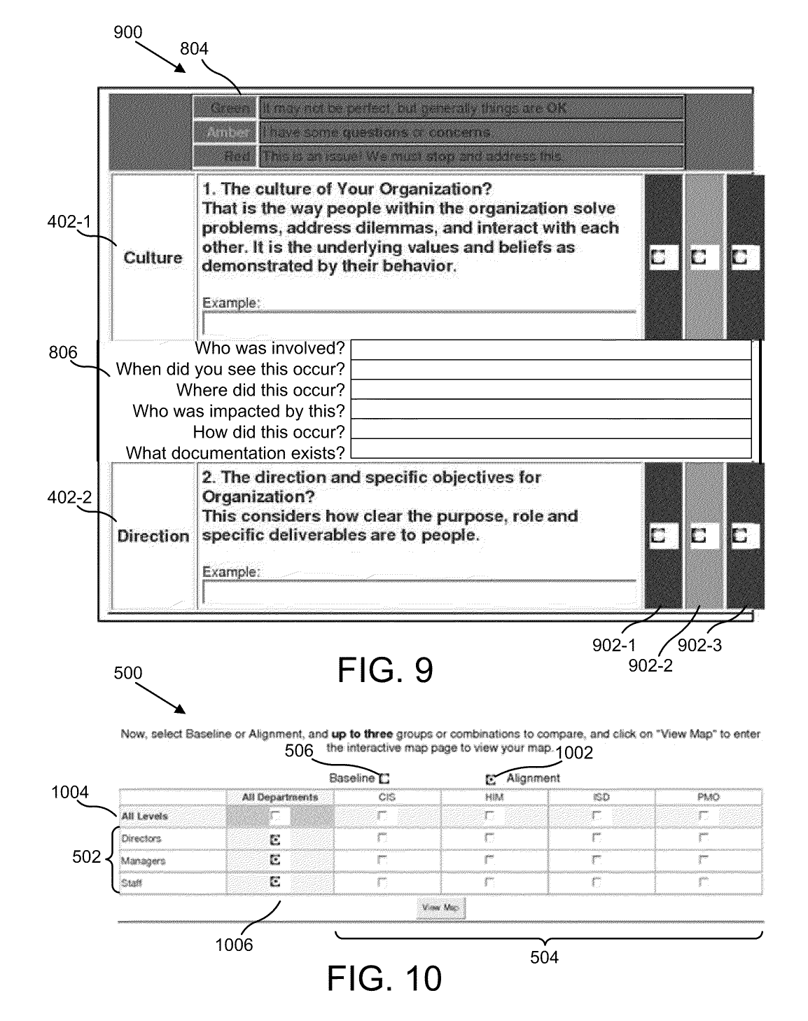

FIG. 9 is an integrative input screen 900 of the survey that solicits a perceptional characterization 802 of organizational aspects 402 of the alignment between the companies. The integrative predetermined responses 804 are repeated at the top of the input screen 900 for the convenience of the respondent. The specific follow-up questions 806 may also be provided to prompt the respondent to explore the response in greater detail. In a further embodiment, a minimum number of responses to the follow-up questions 806 may be required. Corresponding color-coded check boxes 902-1 to 902-3 are provided for the selection of the survey response regarding each organizational aspect 402.

FIG. 10 is the dialog box 500 specifying the output of the reporting module 206 as to the alignment between the companies. As noted previously, the output may be selected according to demographic groups 502 and organizations 504 within the company, comprising management levels and departments, respectively. In the example shown, the alignment check box 1002 has been selected, which further requires that the levels and departments be explicitly specified. The first row 1004 may used to specify that all levels be rolled together across one or more departments. The first column 1006 may be used to specify that all departments be rolled together across one or more levels. In this case, all checkboxes in the first column 1004 have been selected except for the checkbox in the first row 1002, with the effect all departments will be rolled together across each separate level.

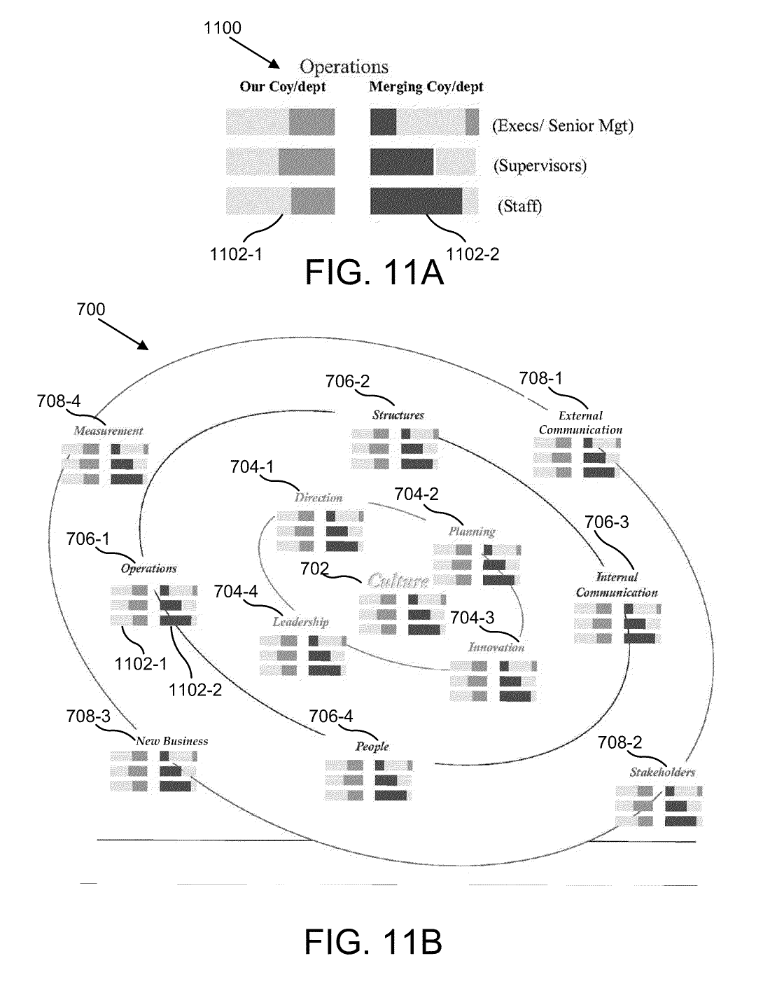

FIG. 11A is a visual summary 1100 of the survey data for an organizational aspect 402 that juxtaposes a summary of the survey data for the first company, comprising a first stacked bar chart 1102-1, with that of the second company, comprising a second stacked bar chart 1102-2, across each demographic group, comprising a management level. The stacked bar charts 1102 are color coded, with the red responses 804-3 summarized on the left end of the stack, the yellow responses 804-2 summarized in the middle of the stack, and the green responses 804-1 summarized on the right end of the stack. As can be seen in this example, the first stacked bar charts 1102-1, representing the acquiring company, exhibit a roughly even split between neutral and positive responses at all management levels, whereas the second stacked bar charts 1102-2, representing the acquired company, exhibit increasingly negative responses at successively lower management levels, as well might be the case if the acquisition were a hostile takeover.

In a further embodiment, the responses for both the first company and the second company may be rolled together into a single stacked bar chart 1102, with the first stacked bar chart 1102-1 summarizing the results of a first administration of the demographic survey, and the second stacked bar chart 1102-2 summarizing the results of a second administration of the demographic survey, to assess the progress made towards integration of the companies between the first and second survey.

FIG. 11B is an arrangement of the visual summaries 1100 in the pictorial representation 700 of an interrelationship between the organization aspects 402 of the alignment between the companies. In one embodiment as described above, wherein the first stacked bar chart 1102-1 corresponds to the first company and the second stacked bar chart 1102-2 corresponds to the second company, the pictorial representation 700 may be referred to as an integration map. In another embodiment as described above, wherein the first stacked bar chart 1102-1 corresponds to a first administration of the demographic survey for both companies and the second stacked bar chart 1102-2 corresponds to a second administration of the demographic survey for both companies, the pictorial representation 700 may be referred to as a comparison map.

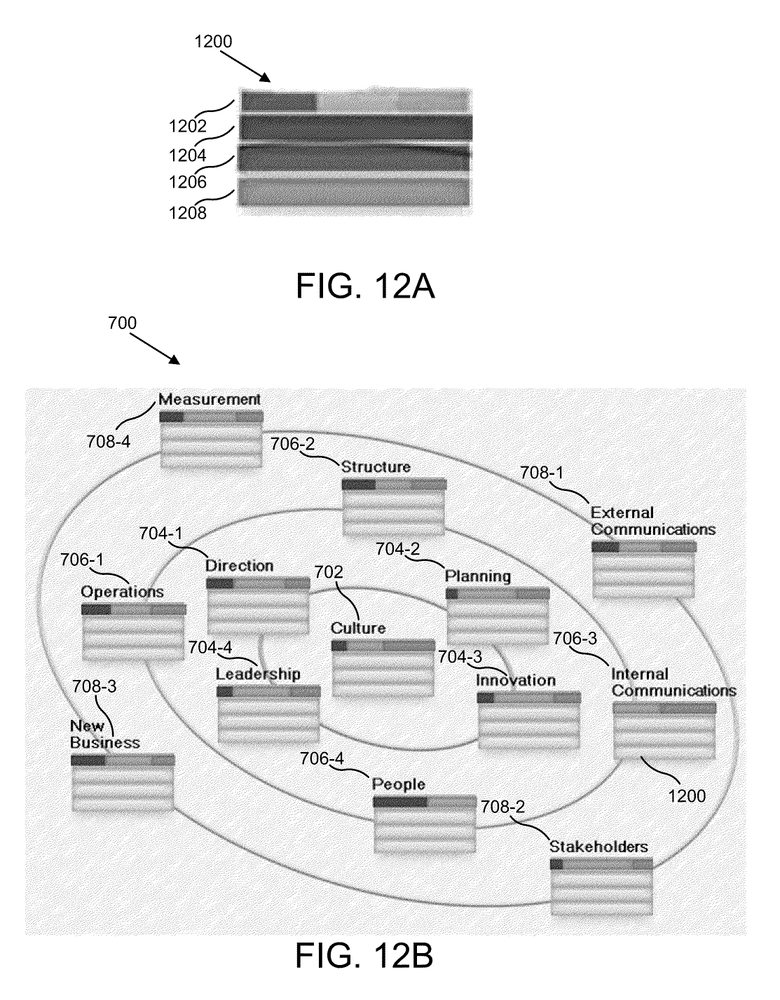

FIG. 12A is a visual summary 1200 of the survey data for an organizational aspect 402 that combines the survey data for the first company with that of the second company into a single representation for the post-merger company. All of the response data from the first stacked bar chart 1102-1 is automatically combined with all of the response data of the second stacked bar chart 1102-2 into a single combined bar 1202. It is color coded in the same way, with the red responses 804-3 summarized on the left end of the combined bar 1202, the yellow responses 804-2 summarized in the middle of the combined bar 1202, and the green responses 804-1 summarized on the right end of the combined bar 1202.

Below the combined bar 1202, an impacts bar 1204, a root causes bar 1206, and an actions bar 1208 may provide an interface to the recommendation module 108 to generate action recommendations to address the root causes of the impacts regarding the merger based upon the survey data in the database. Thus visual summary 1200 may be selected by a user to reveal the impacts, root causes, and action recommendations with respect to the corresponding organizational aspect 402.

FIG. 12B is an arrangement of the visual summaries 1200 in the pictorial representation 700 of an interrelationship between the organization aspects 402 of the post-merger company. In this embodiment, the pictorial arrangement 700 may be referred to as an action map. The maps retain the same familiar and intuitive layout in all cases, but the specific content varies from one stage of the process to the next, analogous to the way that hour markings on a clock face remain the same, but the hands move with time.

In one embodiment, the visual summary 1200 may show the work done on impacts, root causes and actions. A user may choose an organizational aspect 402 of concern to work on, such as internal communications. Once chosen, the visual summary 1200 of the selected organizational aspect 402 may become highlighted, and a general menu may appear. A first menu item may permit the user to display the facts obtained from the survey. The user may select the facts to be worked on and add them to a list.

A second menu item may permit the user to identify impacts of a selected fact from the list. Note that the visual summary 1200 may remain highlighted, so the user is still working on facts that originated with that organizational aspect 402. The user may select one fact at a time, and specify how that fact impacts one or more of the other organizational aspects 402 by choosing a color to show the type of impact using the red, green, and yellow color coding as heretofore defined. The chosen color for each impacted organizational aspect 402 may now appear on the action map, on the impacts bar 1204. If an organizational aspect is not impacted and no color was chosen, then the corresponding impacts bar 1204 may be blank.

Although impacts for other facts may have been completed, only the impacts for the currently selected fact may appear on the impacts bars 1204 on the action map. To display all the impacts for some or all of the facts that the user may have completed, menu items to select some or all impacts may be provided. The selected impacts may then appear in percentages (for instance, 20% green, 10% yellow, and 70% red) on the impacts bar 1204, in the similar fashion as on the combined bar 1202.

A third menu item may permit the user to identify root causes. As before, the visual summary 1200 of the selected organizational aspect 402 may remain highlighted. The user may select one fact at a time, and specify which organizational aspect 402 is the root cause. The root causes bar 1206 for the selected organizational aspect 402 may then be color coded blue. A dialog box may appear to allow the user to enter an explanation of the root cause.

Although root causes for other facts may have been completed, only the impacts for the currently selected fact may appear on the root causes bars 1206 on the action map. To display all of the root causes for some or all of the facts that the user may have completed, menu items to select some or all root causes may be provided. Clicking on a blue root causes bar 1206 may then display the associated root causes. This capability to select one or more root causes may also be used together in conjunction with the aforementioned capability to select one or more impacts.

A fourth menu item may permit the user to create actions. As before, the visual summary 1200 of the selected organizational aspect 402 may remain highlighted. The user may select one fact at a time, causing the impacts to appear on the impacts bars 1204. The user may then select an impact, causing the root causes to appear on the root causes bars 1206. The user may select a root cause, and a dialog box may appear to allow the user to create an action to address the selected root cause. The user may then test how that action affects one or more of the other organizational aspects 402 by choosing a color to show the type of impact using the red, green, and yellow color coding as heretofore defined. The chosen color for each impacted organizational aspect 402 may now appear on the action map, on the actions bar 1208. If the user is not satisfied with the action, the user may change the action and its effects and re-test the action. The new effect then replaces the previous one on the actions bar 1208. More than one action may be specified for a given root cause.

The user may repeat the foregoing steps for all facts associated with all of the organizational aspects 402. When process is completed, an action plan may then be displayed, showing all of the actions that were created.

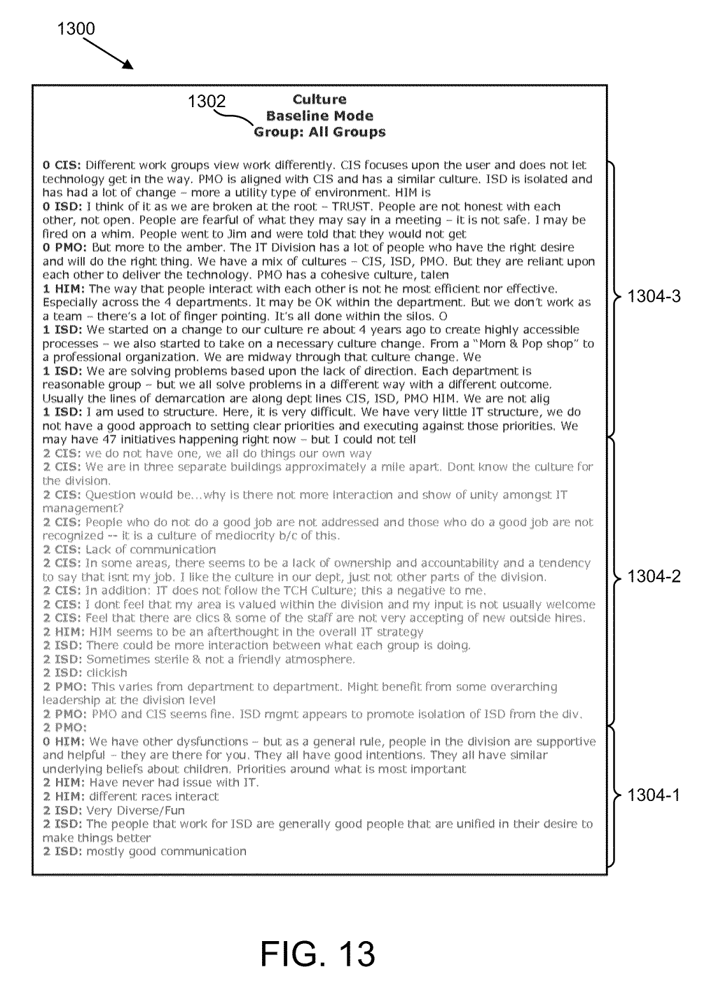

FIG. 13 is an output screen 1300 showing more detailed survey data received in response to a follow-up question 306 regarding the perceptional characterization 302, grouped and color-coded in a corresponding manner. In one embodiment, the output screen 1300 could be revealed in response to a user selecting the visual summary 600, 1100 or 1200 of the core aspect 702 of culture on the pictorial representation 700. The mechanism of selection may comprise a mouse-over, a double-click, and so forth. In a further embodiment, selecting only a part of the visual summary 600, 1100 or 1200 such as a specific colored bar 602 or stacked bar chart 1102 for one of the companies or demographic groups 502, may reveal only the corresponding subset of the detailed survey data.

In the example shown, the selection was apparently made of visual summary 600 with its implicit inclusion of all demographic groups 502 as confirmed by the group indication 1302 of ‘all groups’. The same color coding scheme is used, with the green follow-up responses 1304-1 corresponding to the green baseline predetermined response 304-1 of ‘strong’, the yellow follow-up responses 1304-2 corresponding to the yellow baseline predetermined response 304-2 of ‘neutral’ and the red follow-up responses 1304-3 corresponding to the red baseline predetermined response 304-3 of ‘weak’.

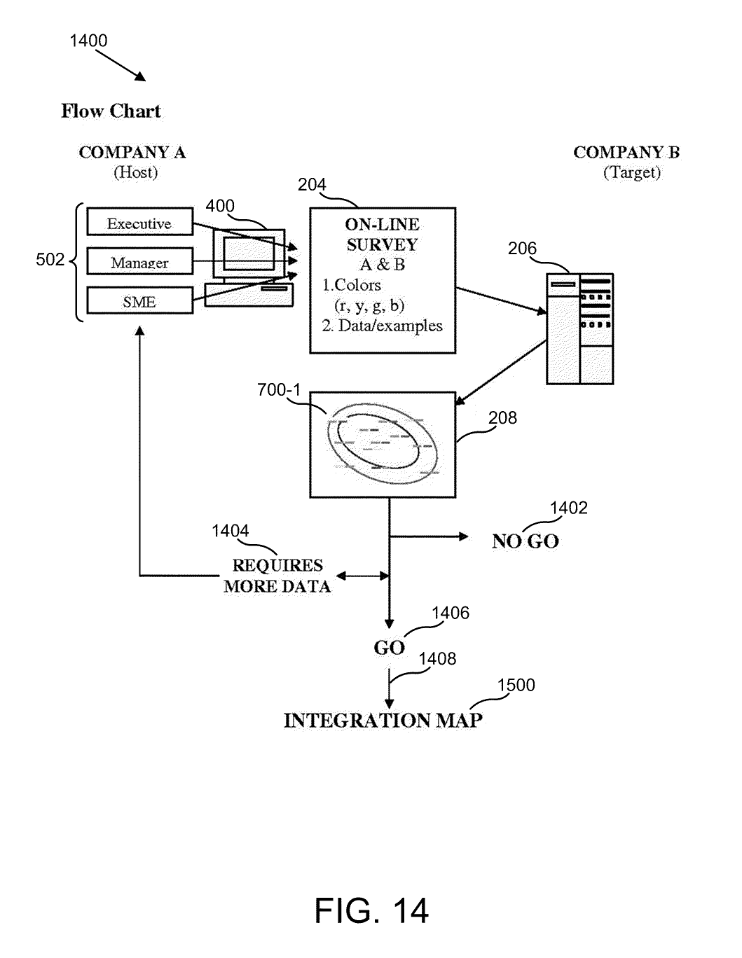

FIG. 14 is a schematic flow chart diagram illustrating one embodiment of a method 1400 for merger and acquisition baseline analysis in accordance with the present invention. The survey module 204 provides a baseline survey via the input screen 400 to respondents within various demographic groups 502 at the executive, manager, and subject matter expert (“SME”) levels. In one embodiment, only the demographic groups 502 of the first company participate in the survey. In another embodiment (not shown) the demographic groups of the second company may also participate in the survey. The database module 206 gathers responses to the survey into a database of survey data regarding the first company and the second company, here respectively shown as host Company A and target Company B. The reporting module 208 displays a summary of the survey data via the merger map 700-1, which in turn is used to help make a decision whether or not to proceed with the merger or acquisition. If the decision is a no go 1402 then the method 1400 ends. If more data is required 1404 then the foregoing steps may be repeated to produce a new merger map 700-1, or supplementary data to may be applied directly by the decision makers to augment their evaluation of the merger map 700-1. If the decision is a go 1406 then the method 1400 ends and a method 1500 is invoked 1408 as shall be described presently.

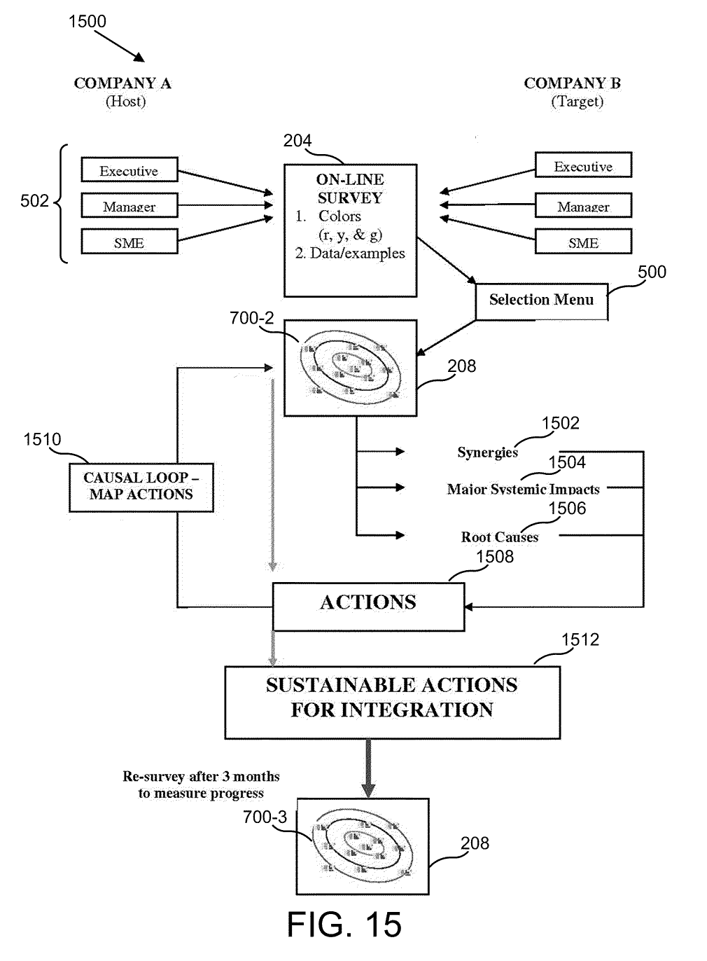

FIG. 15 is a schematic flow chart diagram illustrating one embodiment of the method 1500 for merger and acquisition integrative analysis in accordance with the present invention. The survey module 204 provides an integrative survey to respondents within various demographic groups 502 at the executive, manager, and subject matter expert (“SME”) levels of both Company A and B. As previously shown for the survey method 1400, the database module 206 gathers responses to the survey into a database of survey data. In the dialog box 500 the alignment checkbox 1002 is selected. In response to the parameters specified in the dialog box 500, the reporting module 208 displays a summary of the survey data via the integration map 700-2.

Using the perspectives highlighted by the integration map 700-2 the major areas of synergy 1502 between the two companies may be clearly identified, and the key systemic issues 1504 that will most impact the integration. Finally, the root causes 1506 of the systemic issues 1504 can be tracked and integration action recommendations 1508 developed to ensure a smooth integration. In one embodiment, the action recommendations 1508 may be generated at least in part by the recommendation module 108. Using systems thinking causal loop analysis 1510, the action recommendations 1508 may be mapped back against the original system integration map 700-2. This helps determine if the integration action recommendations 1508 are sustainable 1512 and convergent toward success of the merger. In a further embodiment, the causal loop analysis 1510 may be performed at least in part by the recommendation module 108.

If the action recommendations 1508 are sustainable 1512 then they are implemented, and progress may be subsequently evaluated after a suitable period of time has elapsed, such as three months, by repeating the foregoing process of gathering the survey data and displaying the comparison map 700-3 in which the first stacked bar chart 1102-1 corresponds to the initial administration of the integrative survey and the second stacked bar chart 1102-2 corresponds to the re-administration of the integrative survey.

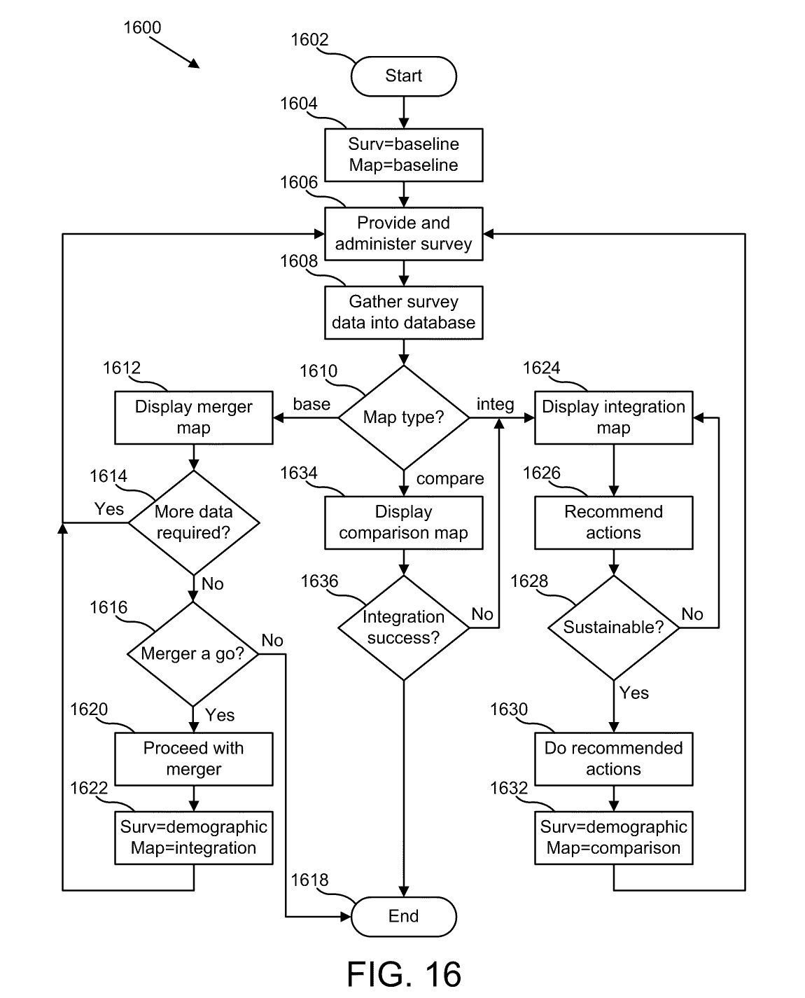

FIG. 16 is a more detailed schematic flow chart diagram illustrating one embodiment of a method 1600 for merger and acquisition integrative analysis as performed by the present invention. The method 1600 starts 1602 and specifies 1604 both survey type and map type as baseline. The baseline survey is provided 1606 and administered to the respondents, and the survey data is gathered 1608 into the database. The map type is ascertained 1610 as baseline and the corresponding merger map 700-1 is displayed 1612. If more data is required 1614 then the baseline survey is provided 1606 again and the method 1600 repeats from that point. If no more data is required 1614 then a decision is made as to whether the merger is a go 1616. If not, the method 1600 ends 1618. If so, then the companies proceed 1620 with the merger.

After completing the merger, a demographic survey type and integration map type are specified 1622. The demographic survey is then provided 1606 and administered to the respondents, and the survey data is gathered 1608 into the database. The map type is ascertained 1610 as integration and the corresponding integration map 700-2 is displayed 1624. Action recommendations are generated 1626, and causal loop analysis 1510 is used to determine whether the recommended actions are sustainable 1628. If not, the integration map 700-2 is displayed 1624 again and revised action recommendations are generated 1626. The action recommendations are then implemented 1630 once they have been deemed sustainable 1628.

After implementing 1630 the action recommendations and allowing a sufficient amount of time for them to take effect, a demographic survey type and comparison map type are specified 1632. The demographic survey is again provided 1606 and administered to the respondents, and the survey data is gathered 1608 into the database. The map type is ascertained 1610 as comparison and the corresponding comparison map 700-3 is displayed 1634. If the integration of the companies is not assessed as being a success 1636, then the latest integration map is displayed 1624 and the method 1600 repeats from that point. Otherwise, the method 1600 ends 1618 with the companies having been successfully merged and integrated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a survey module that provides a survey regarding organizational aspects, including both subjective aspects and objective aspects;
a database module that gathers responses to the survey regarding a first company and a second company into a database of survey data, wherein the first company and the second company are candidates for a merger; and
a reporting module that displays a graphic that presents a visual summary of the survey data for each organizational aspect, the visual summaries arranged in a pictorial representation of an interrelationship between the organizational aspects
wherein the survey module, the database module, and the reporting module comprise one or more of logic hardware and executable code, the executable code stored on one or more computer-readable media.

2. The apparatus of claim 1, wherein the survey solicits a perceptional characterization of the organizational aspect among a set of predetermined responses.

3. The apparatus of claim 2, wherein the predetermined responses comprise one or more of strong, neutral, weak, and unknown, and wherein the visual summary juxtaposes a summary of the survey data for the first company with that of the second company.

4. The apparatus of claim 2, wherein the predetermined responses comprise one or more of synergy, potential barrier, and barrier, as regards the integration of the first company with the second company, and wherein the visual summary juxtaposes summaries of the survey data for one or more demographic groups.

5. The apparatus of claim 2, wherein the visual summary is color-coded by predetermined response.

6. The apparatus of claim 2, wherein the perceptional characterization is supplemented by one or more follow-up questions, comprising at least a request for an example to support the predetermined response.

7. The apparatus of claim 1, wherein the pictorial representation comprises concentric circles, having one or more core aspects centrally disposed, one or more strategic aspects disposed around an inner circle, one or more operational aspects disposed around a middle circle, and one or more external aspects disposed around an outer circle.

8. The apparatus of claim 1, wherein the subjective aspects comprise one or more of culture, leadership, innovation, people, internal communications, external communications, new business, and stakeholders.

9. The apparatus of claim 1, wherein the objective aspects comprise one or more of direction, planning, operations, structures, and measurement.

10. A system comprising:
a computing environment,
a survey module that provides a survey regarding organizational aspects, including both subjective aspects and objective aspects;
a database module that gathers responses to the survey regarding a first company and a second company into a database of survey data, wherein the first company and the second company are candidates for a merger; and
a reporting module that displays a graphic that presents a visual summary of the survey data for each organizational aspect, the visual summaries arranged in a pictorial representation of an interrelationship between the organizational aspects
wherein the survey module, the database module, and the reporting module comprise one or more of logic hardware and executable code, the executable code stored on one or more computer-readable media within the computing environment.

11. The system of claim 10, wherein the computing environment is internet-based.

12. The system of claim 10, wherein the visual summary is selectable by a user to reveal more detailed survey data with respect to the corresponding organizational aspect.

13. The system of claim 10, further comprising a recommendation module that generates action recommendations to address root causes of impacts regarding the merger based upon the survey data in the database, wherein the visual summary is selectable by a user to reveal the impacts, root causes, and action recommendations with respect to the corresponding organizational aspect.

14. A computer program product comprising a computer readable medium having computer usable program code executable to perform operations, the operations of the computer program product comprising:
providing a survey regarding organizational aspects, including both subjective aspects and objective aspects;
gathering responses to the survey regarding a first company and a second company into a database of survey data, wherein the first company and the second company are candidates for a merger; and
displaying a graphic that presents a visual summary of the survey data for each organizational aspect, the visual summaries arranged in a pictorial representation of an interrelationship between the organizational aspects.

15. The computer program product of claim 14, further comprising a step of generating action recommendations to address root causes of impacts regarding the merger based upon the survey data in the database.

16. A machine-implemented method comprising the steps of:
providing a survey regarding organizational aspects, including both subjective aspects and objective aspects;
gathering responses to the survey regarding a first company and a second company into a database of survey data, wherein the first company and the second company are candidates for a merger; and
displaying a graphic that presents a visual summary of the survey data for each organizational aspect, the visual summaries arranged in a pictorial representation of an interrelationship between the organizational aspects.

17. The method of claim 16, wherein the visual summary juxtaposes a summary of the survey data for the first company with that of the second company, to facilitate making a decision whether or not to proceed with the merger.

18. The method of claim 16, wherein the visual summary juxtaposes summaries of the survey data for one or more demographic groups, to facilitate integration of the first company with the second company, and further comprising a step of repeating the steps of gathering and displaying, to facilitate ongoing measurement and tracking of the integration.

19. The method of claim 16, further comprising a step of generating action recommendations to address root causes of impacts regarding the merger based upon the survey data in the database.

20. The method of claim 19, wherein the step of generating further comprises causal loop analysis to determine whether the action recommendations are sustainable and convergent toward success of the merger.
